(19) United States
(12) Patent Application Publication
(10) Pub. No.: US 2017/0168249 A1
(43) Pub. Date: Jun. 15, 2017

(54) OPTICAL MODULE AND OPTICAL TRANSMISSION DEVICE

(71) Applicant: OCLARO JAPAN, INC., Sagamihara (JP)

(72) Inventors: Fumihide MAEDA, Odawara (JP); Koichi OMORI, Funabashi (JP); Yoshikuni UCHIDA, Yokohama (JP); Yuji SEKINO, Zama (JP); Koji TAKEGUCHI, Sagamihara (JP); Kazutaka NAGOYA, Kokubunji (JP); Hiroyoshi ISHII, Yokohama (JP)

(21) Appl. No.: 15/362,864

(22) Filed: Nov. 29, 2016

(30) Foreign Application Priority Data
Dec. 14, 2015 (JP) 2015-243205
Aug. 29, 2016 (JP) 2016-166718

(51) Int. Cl. G02B 6/42

(52) U.S. Cl. CPC G02B 6/4206; G02B 6/4278

(57) ABSTRACT

An optical module is attachable to and detachable from a cage. The optical module includes a module case, a slider attached to the outside of the module case for releasing coming-off prevention from the cage, and a leakage reducing layer intervening between the module case and the slider to reduce leakage of an electromagnetic wave.

### CROSS-REFERENCE TO RELATED APPLICATION

The present application claims priority from Japanese applications JP2015-243205 filed on Dec. 14, 2015, and JP2016-166718 filed on Aug. 29, 2016, the contents of which are hereby incorporated by reference into this application.

### BACKGROUND OF THE INVENTION

1. Field of the Invention

The present invention relates to an optical module and an optical transmission device.

2. Description of the Related Art

As an optical module used in optical fiber communication, an optical module having an attachable and detachable, and pluggable structure for easy replacement due to breakage, performance degradation, or the like has been known (see JP 2008-257235 A and JP 2008-233645 A). Such an optical module is configured to be attachable to and detachable from a cage mounted on a circuit board including an electronic circuit, and coming-off prevention from the cage is achieved with an engaging portion that catches on a claw formed on the cage. The coming-off prevention is released with a slider of the optical module.

In recent years, the transmission speed becomes higher in addition to an increase in signal transmission amount, so that the operating frequency of an electric signal becomes high. When the operating frequency is low, electromagnetic interference can be suppressed even if the gap between the optical module and the cage is somewhat large. However, when the operating frequency is high, electromagnetic waves pass through the gap between the optical module and the cage even if the gap is small, and the electromagnetic waves are emitted to the outside of a host device.

### SUMMARY OF THE INVENTION

It is an object of the invention to enhance a shielding function against electromagnetic interference.

(1) An optical module according to an aspect of the invention is an optical module attachable to and detachable from a cage, including: a module case; a slider attached to the outside of the module case for releasing coming-off prevention from the cage; and a leakage reducing layer intervening between the module case and the slider to reduce leakage of an electromagnetic wave. According to the aspect of the invention, since the electromagnetic wave leaking between the module case and the slider can be reduced by the leakage reducing layer, a shielding function against electromagnetic interference can be enhanced.

(2) The optical module according to (1), wherein the leakage reducing layer may be configured of one of an electromagnetic wave absorber that converts energy of the electromagnetic wave to thermal energy and a conductor configured to have elasticity higher than that of a surface of the module case and provide shielding against the electromagnetic wave.

(3) The optical module according to (2), wherein the electromagnetic wave absorber may be one substance selected from the group consisting of a resistor that absorbs an electric current generated by the electromagnetic wave with resistance, a dielectric that absorbs the electromagnetic wave using dielectric loss due to the polarization response of molecules, and a magnetic substance that absorbs the electromagnetic wave using magnetic loss of a magnetic material.

(4) The optical module according to (2), wherein the conductor may be a metal fabric.

(5) The optical module according to (3), wherein the resistor may have a conductivity of 1 S/m or more and 1000 S/m or less.

(6) The optical module according to any one of (1) to (5), wherein the cage may include a shield finger provided in contact with the optical module so as to provide electromagnetic shielding, and at least a portion of the leakage reducing layer may be provided at a position facing a contact portion of the shield finger and the optical module when the optical module is attached to the cage.

(7) The optical module according to (6), wherein the cage may include an insertion port for inserting the optical module, and the shield finger may be provided adjacent to the insertion port in the interior of the cage.

(8) The optical module according to (7), wherein the leakage reducing layer may be provided so as to include a portion extending from the position facing the contact portion in a direction toward the insertion port.

(9) The optical module according to (7) or (8), wherein the leakage reducing layer may be provided so as to include a portion extending from the position facing the contact portion in a direction away from the insertion port.

(10) An optical transmission device according to another aspect of the invention includes; an optical module; and a cage including a first shield finger provided in contact with the optical module so as to provide electromagnetic shielding, the cage being configured to allow the optical module to be attachable thereto and detachable therefrom, wherein the optical module includes a module case, a slider attached to the outside of the module case for releasing coming-off prevention from the cage, and a leakage reducing layer intervening between the module case and the slider at a position facing the first shield finger to reduce leakage of an electromagnetic wave when the optical module is attached to the cage. According to the aspect of the invention, since the electromagnetic wave leaking between the module case and the slider can be reduced by the leakage reducing layer, a shielding function against electromagnetic interference can be enhanced.

(11) The optical transmission device according to (10), further including: a circuit board on which the cage is mounted; and a front plate including a hole through which an end portion of the cage is inserted, wherein the cage may include a second shield finger provided in contact with an edge of the hole of the front plate so as to provide electromagnetic shielding.

(12) The optical transmission device according to (11), wherein the first shield finger and the second shield finger may be located at positions overlapping each other.

### BRIEF DESCRIPTION OF THE DRAWINGS

FIG. 1 is a perspective view showing a portion of an optical transmission device according to an embodiment of the invention.

FIG. 2 is a side view of the optical transmission device shown in FIG. 1.

FIG. 3 is a cross-sectional view of the optical transmission device shown in FIG. 2, taken along line III-III.

FIG. 4 is an enlarged schematic view of a portion of the optical transmission device shown in FIG. 3.

FIG. 5 is a perspective view showing an optical module according to the embodiment of the invention.

FIG. 6 is an exploded perspective view of the optical module shown in FIG. 5.

FIG. 7 is a schematic view of a cross-section of the optical module shown in FIG. 5, taken along line VII-VII.

FIG. 8 is a diagram showing Modified Example 1 of the optical transmission device and the optical module according to the embodiment of the invention.

FIG. 9 is a diagram showing Modified Example 2 of the optical transmission device and the optical module according to the embodiment of the invention.

FIG. 10 is a diagram showing Modified Example 3 of the optical transmission device and the optical module according to the embodiment of the invention.

FIG. 11 is a diagram showing Modified Example 4 of the optical transmission device and the optical module according to the embodiment of the invention.

FIG. 12 is a diagram showing Modified Example 5 of the optical transmission device and the optical module according to the embodiment of the invention.

FIG. 13 is a diagram showing Modified Example 6 of the optical transmission device and the optical module according to the embodiment of the invention.

### DETAILED DESCRIPTION OF THE INVENTION

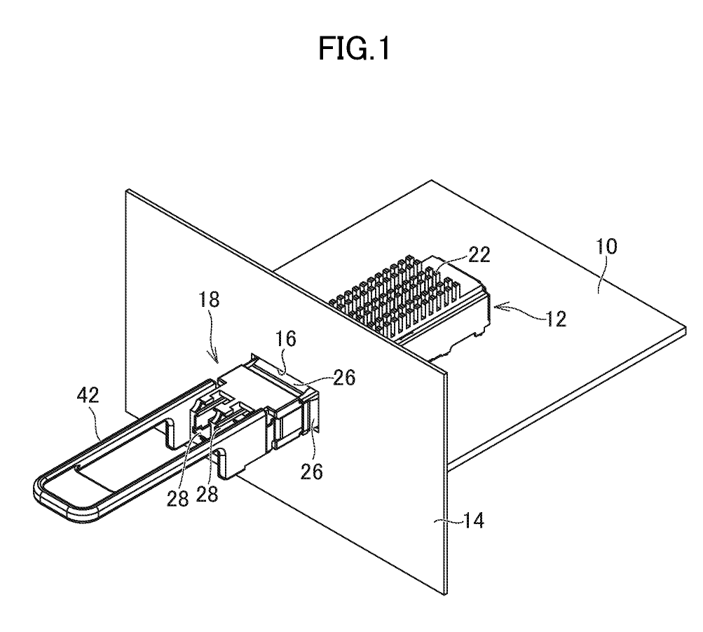

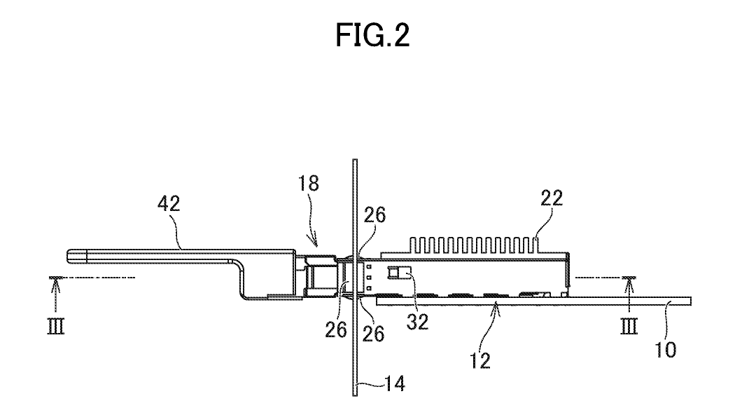

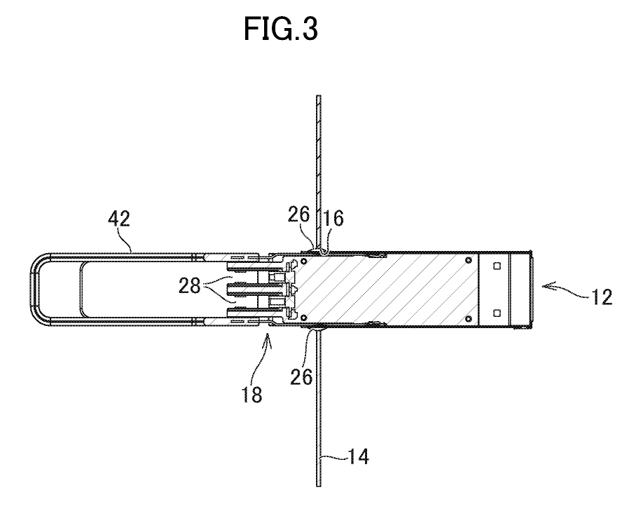

Hereinafter, an embodiment of the invention will be described with reference to the drawings. FIG. 1 is a perspective view showing a portion of an optical transmission device according to the embodiment of the invention. FIG. 2 is a side view of the optical transmission device shown in FIG. 1. FIG. 3 is a cross-sectional view of the optical transmission device shown in FIG. 2, taken along line III-III.

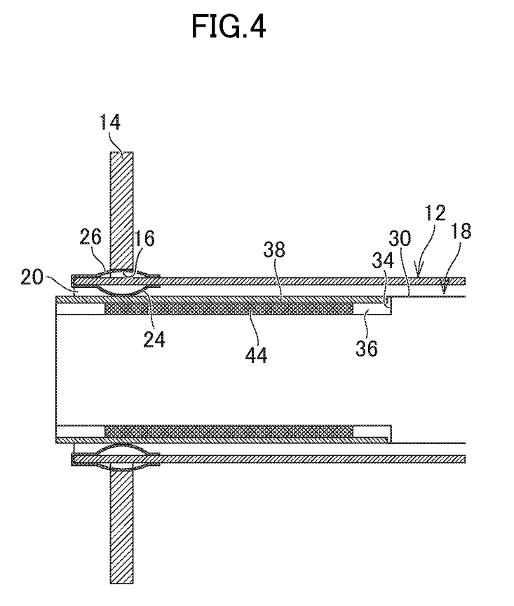

The optical transmission device includes a circuit board 10. Many cages 12 are mounted on the circuit board 10, and one of the cages 12 is shown in FIG. 1. The end portion of the cage 12 is inserted through a hole 16 of a front plate 14. The front plate 14 serves as the frame of the cage 12 and thus is also referred to as “bezel”. The cage 12 includes an insertion port 20 (see FIG. 4) for inserting an optical module 18, is hollow, and is configured to allow the optical module 18 to be attachable thereto and detachable therefrom. The cage 12 is made of a conductor such as metal, and is connected to the ground potential through the circuit board 10. Herein, although not particularly limited, one cage 12 accommodates one optical module 18. An electric connector (not shown) that is fixed and electrically connected to the circuit board 10 is disposed at the back of the cage 12 in the insertion direction of the optical module 18, and serves as a guide for the optical module 18. A heat spreader 22 is attached to the cage 12 for enhancing a heat dissipation effect, so that the heat of the optical module 18 is dissipated.

FIG. 4 is an enlarged schematic view of a portion of the optical transmission device shown in FIG. 3. The cage 12 includes a first shield finger 24. The first shield finger 24 is provided in contact with the optical module 18 so as to provide electromagnetic shielding. The first shield finger 24 is provided adjacent to the insertion port 20 of the cage 12 in the interior of the cage 12. In FIG. 4, a pair of the first shield fingers 24 laterally interposing the optical module 18 therebetween are shown, and further, a pair of first shield fingers (not shown) vertically interposing the optical module 18 therebetween may be provided. The first shield finger 24 is formed of, for example, a metal piece or the like.

The cage 12 includes a second shield finger 26. The second shield finger 26 is provided in contact with the edge (inner surface) of the hole 16 of the front plate 14 so as to provide electromagnetic shielding. In FIG. 4, a pair of the second shield fingers 26 laterally projecting oppositely to each other are shown, and further, a pair of second shield fingers 26 (see FIG. 1) vertically projecting oppositely to each other may be provided. The second shield finger 26 is formed of, for example, a metal piece or the like.

The first shield finger 24 and the second shield finger 26 are located at positions overlapping each other as shown in FIG. 4. Hence, since the positions to provide shielding against an electromagnetic wave overlap each other on the inside and the outside of the cage 12, the effect of shielding is high. The first shield finger 24 and the second shield finger 26 are bent so as to project respectively from the inner surface and the outer surface of the cage 12 in opposite directions. In the example shown in FIG. 4, the first shield finger 24 and the second shield finger 26 are integrated together to constitute a clip, and fixed together with the end portion of the cage 12 interposed therebetween.

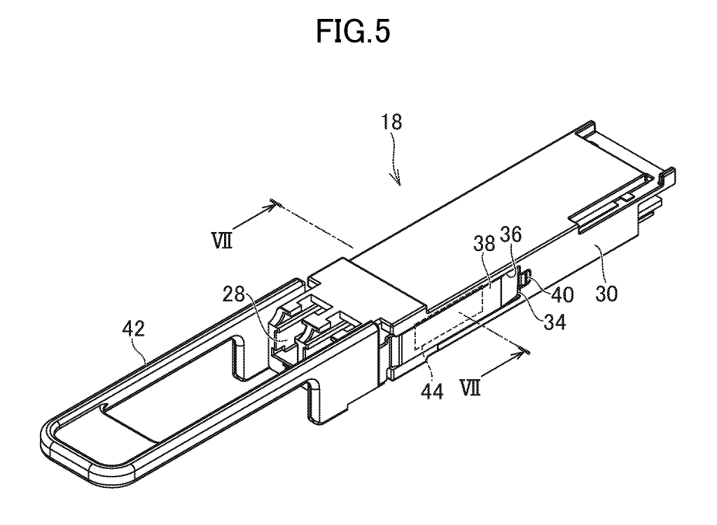

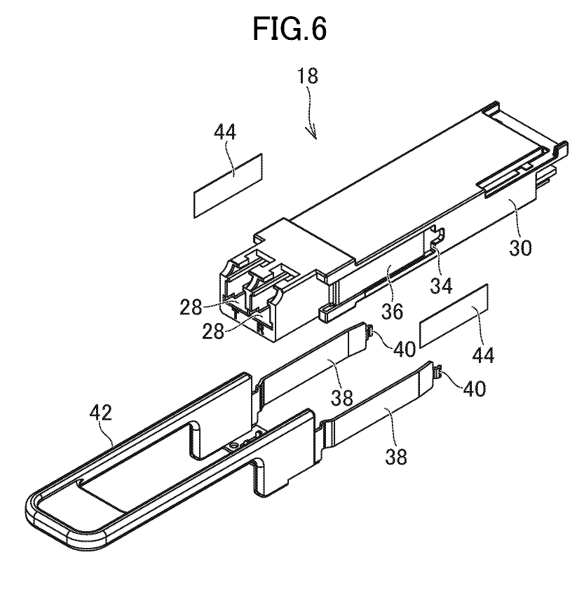

FIG. 5 is a perspective view showing the optical module 18 according to the embodiment of the invention. FIG. 6 is an exploded perspective view of the optical module 18 shown in FIG. 5. The optical module 18 includes an optical subassembly (not shown) for converting an optical signal and an electric signal at least from one to the other. Examples of the optical subassembly include an optical transmitter module (transmitter optical subassembly (TOSA)) that includes a light emitting element such as a semiconductor laser therein, converts an electric signal to an optical signal, and transmits the optical signal, an optical receiver module (receiver optical subassembly (ROSA)) that includes a light receiving element typified by a photodiode therein and converts a received optical signal to an electric signal, and a bidirectional optical subassembly (BOSA) having the functions of TOSA and ROSA. The optical module 18 is of the quad small form-factor pluggable (QSFP) type or the C form-factor pluggable (CFP) type. The optical module 18 is inserted into the cage 12 of the optical transmission device and is pluggable thereto.

The optical module 18 includes a module case 30 including optical ports 28. An optical fiber (not shown) is inserted into the optical port 28. When the optical module 18 is attached to the cage 12, coming-off prevention is achieved. Specifically, the cage 12 includes a lock tab 32 (see FIG. 2) projecting to the side (inside the cage 12) on which the optical module 18 is disposed. On the other hand, the optical module 18 includes a lock portion 34 to the lock tab 32 (FIGS. 5 and 6).

A groove 36 is formed on each side surface of the module case 30. The groove 36 extends in the insertion direction of the optical module 18, and the end surface of the groove 36 on the back side when the optical module 18 is inserted is the lock portion 34. The lock portion 34 is disposed at the back of the cage 12 beyond the lock tab 32 (FIG. 2) when the optical module 18 is attached to the cage 12. With this configuration, the lock tab 32 and the lock portion 34 are fitted together, and the coming-off prevention of the optical module 18 can be achieved.

The optical module 18 includes a slider 38 for releasing the coming-off prevention from the cage 12. A pair of the sliders 38 are attached to both sides of the module case 30. The slider 38 is movable between the module case 30 and the cage 12 along the attachment direction of the optical module 18 to the cage 12. The pair of sliders 38 are disposed such that each of the sliders 38 can slide in the length direction while being guided by the groove 36 of the module case 30. The moving direction of the slider 38 is regulated by the groove 36. The slider 38 includes a projecting portion 40 projecting outward.

In removing the optical module 18, the slider 38 is caused to slide. A grip 42 made of rubber or the like is fixed to the sliders 38, and by pulling the grip 42, the sliders 38 can be caused to slide. The pulling direction is the pull-out direction of the optical module 18. Then, by pushing out the lock tab 32 (FIG. 2) from the inside outward with the projecting portion 40 of the slider 38, the locking between the lock tab 32 and the lock portion 34 is released. In this way, the optical module 18 can be removed from the cage 12.

The module case 30 is made of a conductor such as metal, and blocks most of electromagnetic waves generated from components accommodated inside the module case 30. However, the electromagnetic waves are radiated to the outside of the module case 30 through the opening for connection to the electric connector (not shown), or the like. A portion of the electromagnetic waves propagates through a gap between the module case 30 and the cage 12, and the electromagnetic wave also propagates between the module case 30 and the slider 38. The electromagnetic wave passes between the module case 30 and the slider 38 and is emitted to the outside of the front plate 14, giving rise to an increase in the emission amount of electromagnetic wave of the entire optical transmission device.

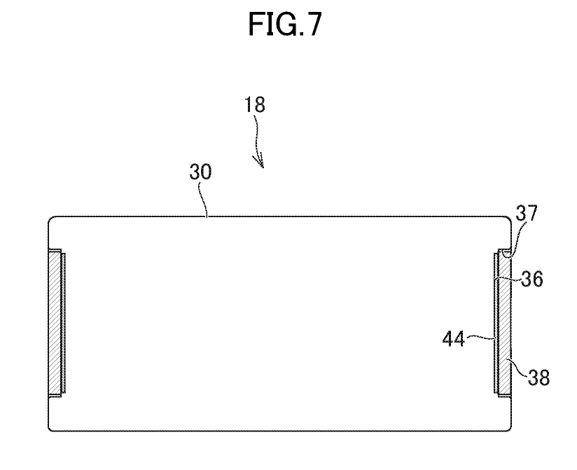

FIG. 7 is a schematic view of a cross-section of the optical module 18 shown in FIG. 5, taken along line VII-VII. The optical module 18 includes a leakage reducing layer 44. The leakage reducing layer 44 intervenes between the module case 30 and the slider 38 to reduce the leakage of an electromagnetic wave. For example, the electromagnetic wave can be blocked or absorbed. The leakage reducing layer 44 may be attached to the module case 30 with a not-shown adhesive (for example, a double-faced tape). In the example of FIG. 7, the groove 36 is located in the side surface of the module case 30, and the leakage reducing layer 44 is located between the bottom surface of the groove 36 and the slider 38. As a modified example, if the leakage reducing layer can be provided also in a narrow region between an internal surface 37 erected from the bottom surface of the groove 36 and the edge surface of the slider 38, the leakage of the electromagnetic wave can be further reduced.

The leakage reducing layer 44 may be an electromagnetic wave absorber that converts the energy of an electromagnetic wave to thermal energy. Alternatively, the electromagnetic wave absorber may be a resistor that absorbs an electric current generated by an electromagnetic wave with resistance. For example, a resistor having a conductivity of 1 S/m or more and 1000 S/m or less can be used. Alternatively, the leakage reducing layer 44 may be a dielectric that absorbs an electromagnetic wave using dielectric loss due to the polarization response of molecules, or may be a magnetic substance that absorbs an electromagnetic wave using magnetic loss of a magnetic material. The leakage reducing layer 44 may be a conductor that provides shielding against the electromagnetic wave. When the conductor is configured to have elasticity higher than that of the surface of the module case 30, the contact area to the slider is increased, and thus a shielding effect against an electromagnetic wave is enhanced. One example of the leakage reducing layer 44 made of a conductor includes a metal fabric (a fabric woven from metal yarns or a nonwoven fabric made of metal). Another example is a fiber of an insulator subjected to metal plating or metal evaporation. The leakage reducing layer 44 is not limited to these examples, and any fabric having conductivity can obtain advantages of the invention.

Further, the leakage reducing layer 44 made of a conductor may be a conductive resin or conductive paste containing a conductive filler such as a metal powder or a carbon powder therein.

As shown in FIG. 4, when the optical module 18 is attached to the cage 12, at least a portion of the leakage reducing layer 44 is provided at a position facing a contact portion of the first shield finger 24 and the optical module 18. The leakage reducing layer 44 includes a portion facing the inner surface of the hole 16 of the front plate 14. Moreover, the leakage reducing layer 44 includes a portion extending from the position facing the contact portion of the first shield finger 24 and the optical module 18 in a direction away from the insertion port 20. The leakage reducing layer 44 also extends slightly in the opposite direction (direction toward the insertion port 20), but this portion may be omitted. That is, the leakage reducing layer 44 may be formed such that the leakage reducing layer 44 does not include the portion extending beyond the position facing the contact portion of the first shield finger 24 and the optical module 18 in the direction of the insertion port 20.

According to the embodiment, the electromagnetic wave leaking between the module case 30 and the slider 38 can be reduced by the leakage reducing layer 44, and therefore, a shielding function against electromagnetic interference can be enhanced.

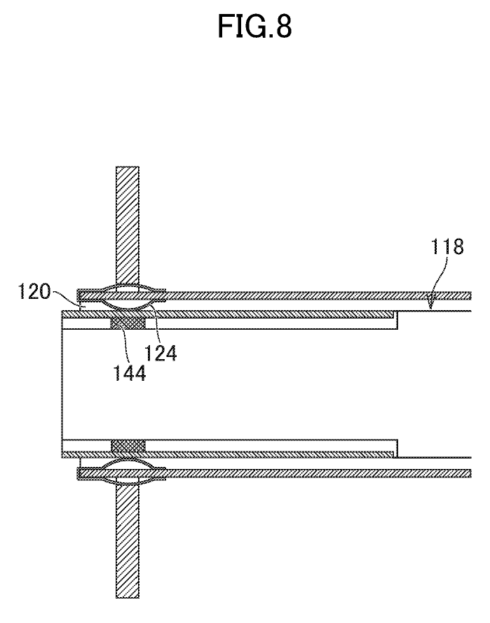

FIG. 8 is a diagram showing Modified Example 1 of the optical transmission device and the optical module according to the embodiment of the invention. In this example, in a leakage reducing layer 144, a portion extending in the opposite direction to an insertion port 120 is shorter than that of the example in FIG. 4. For example, the leakage reducing layer 144 may be provided only at a position facing a contact portion of a first shield finger 124 and an optical module 118. In that case, the leakage reducing layer 144 does not include a portion extending from the position facing the contact portion of the first shield finger 124 and the optical module 118 in a direction away from the insertion port 120. Other contents are as described in the embodiment. An optical transmission device according to Modified Example 1 includes the optical module 118 of Modified Example 1.

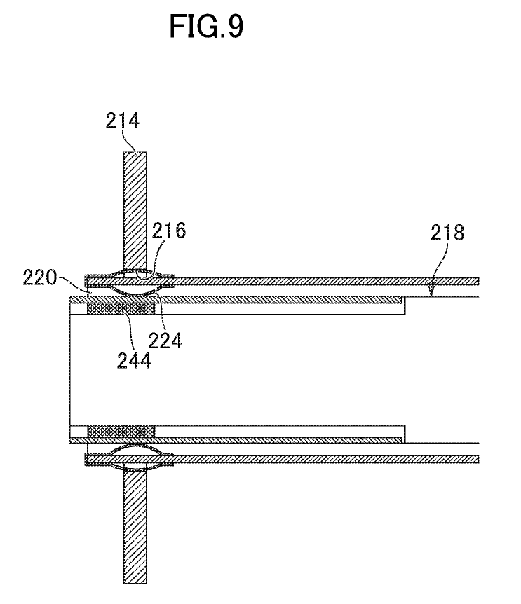

FIG. 9 is a diagram showing Modified Example 2 of the optical transmission device and the optical module according to the embodiment of the invention. In this example, in a leakage reducing layer 244, a portion extending in a direction close to an insertion port 220 is longer than that of the example in FIG. 4 or 8. The leakage reducing layer 244 includes the portion extending from a position facing a contact portion of a first shield finger 224 and an optical module 218 in the direction toward the insertion port 220. Moreover, the leakage reducing layer 244 includes a portion facing a hole 216 of a front plate 214, and extends to reach the outside of the front plate 214. Other contents are as described in the embodiment. An optical transmission device according to Modified Example 2 includes the optical module 218 of Modified Example 2.

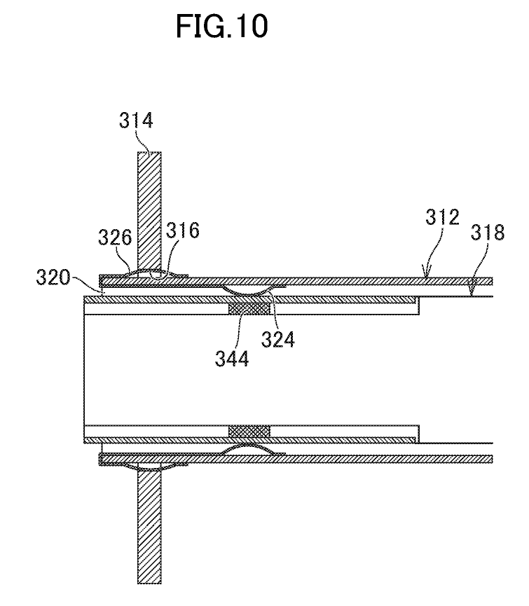

FIG. 10 is a diagram showing Modified Example 3 of the optical transmission device and the optical module according to the embodiment of the invention. In this example, a first shield finger 324 and a second shield finger 326 are located at positions not overlapping each other. Specifically, the first shield finger 324 in contact with an optical module 318 is farther away from an insertion port 320 of a cage 312 than the second shield finger 326. Alternatively, the second shield finger 326 in contact with the edge of a hole 316 of a front plate 314 is closer to the insertion port 320 of the cage 312 than the first shield finger 324. A leakage reducing layer 344 does not face the second shield finger 326 but is located at a position facing a contact portion of the first shield finger 324 and the optical module 318. Other contents are as described in the embodiment. An optical transmission device according to Modified Example 3 includes the optical module 318 of Modified Example 3.

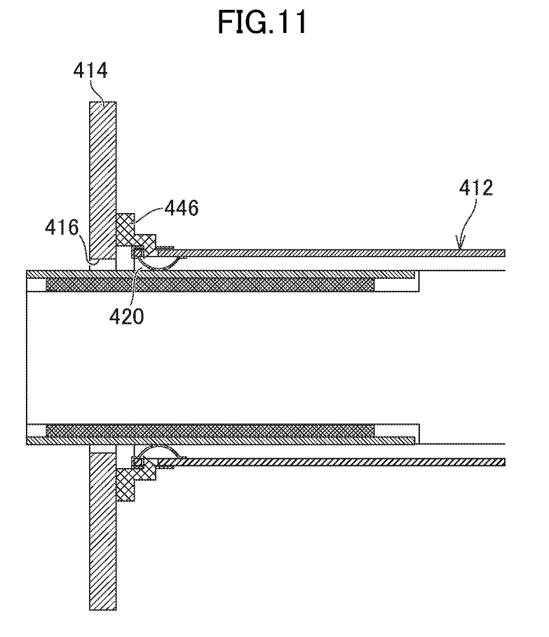

FIG. 11 is a diagram showing Modified Example 4 of the optical transmission device and the optical module according to the embodiment of the invention. This example differs from the structure shown in FIG. 4 in that a cage 412 does not include a second shield finger. Specifically, the cage 412 is not inserted through a hole 416 of a front plate 414 but is adjacent to the rear surface thereof, and an insertion port 420 of the cage 412 and the hole 416 of the front plate 414 are disposed so as to be in communication with each other. A gasket 446 intervenes between the cage 412 and the front plate 414. A conductive sponge (not shown) may be disposed between the gasket 446 and the front plate 414. The gasket 446 is fixed to the end portion of the cage 412. Other contents are as described in the embodiment.

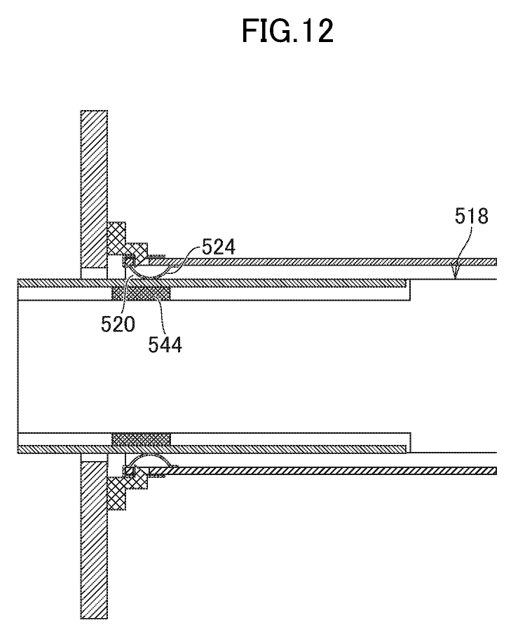

FIG. 12 is a diagram showing Modified Example 5 of the optical transmission device and the optical module according to the embodiment of the invention. In this example, in a leakage reducing layer 544, the lengths of portions extending from a position facing a contact portion of a first shield finger 524 and an optical module 518 in the direction of an insertion port 520 and a direction away from the insertion port 520 are shorter than those of Modified Example 4 shown in FIG. 11.

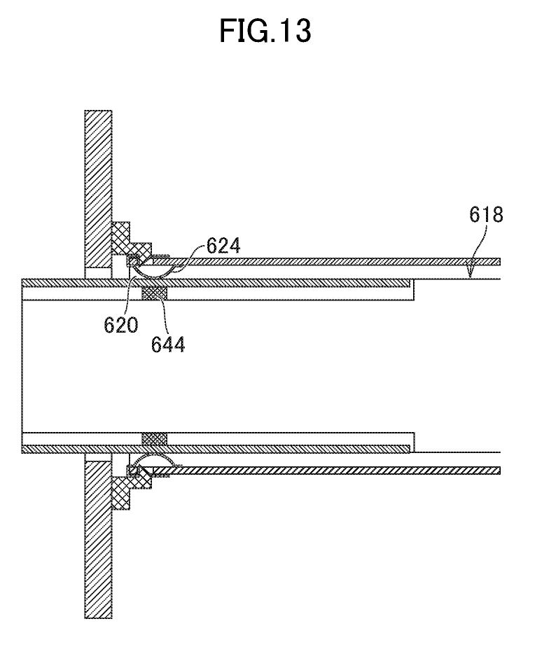

FIG. 13 is a diagram showing Modified Example 6 of the optical transmission device and the optical module according to the embodiment of the invention. In this example, in a leakage reducing layer 644, the lengths of portions extending from a position facing a contact portion of a first shield finger 624 and an optical module 618 in the direction of an insertion port 620 and a direction away from the insertion port 620 are still shorter than those of Modified Example 5 shown in FIG. 12. The leakage reducing layer 644 may be provided only at the position facing the contact portion of the first shield finger 624 and the optical module 618.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An optical module attachable to and detachable from a cage, comprising:
a module case;
a slider attached to the outside of the module case for releasing coming-off prevention from the cage; and
a leakage reducing layer intervening between the module case and the slider to reduce leakage of an electromagnetic wave.

2. The optical module according to claim 1, wherein
the leakage reducing layer is configured of an electromagnetic wave absorber that converts energy of the electromagnetic wave to thermal energy, or a conductor configured to have elasticity higher than that of a surface of the module case and provide shielding against the electromagnetic wave.

3. The optical module according to claim 2, wherein
the electromagnetic wave absorber is one substance selected from the group consisting of a resistor that absorbs an electric current generated by the electromagnetic wave with resistance, a dielectric that absorbs the electromagnetic wave using dielectric loss due to the polarization response of molecules, and a magnetic substance that absorbs the electromagnetic wave using magnetic loss of a magnetic material.

4. The optical module according to claim 2, wherein
the conductor is a metal fabric.

5. The optical module according to claim 3, wherein
the resistor has a conductivity of 1 S/m or more and 1000 S/m or less.

6. The optical module according to claim 1, wherein
the cage includes a shield finger provided in contact with the optical module so as to provide electromagnetic shielding, and
at least a portion of the leakage reducing layer is provided at a position facing a contact portion of the shield finger and the optical module when the optical module is attached to the cage.

7. The optical module according to claim 6, wherein
the cage includes an insertion port for inserting the optical module, and
the shield finger is provided adjacent to the insertion port in the interior of the cage.

8. The optical module according to claim 7, wherein
the leakage reducing layer is provided so as to include a portion extending from the position facing the contact portion in a direction toward the insertion port.

9. The optical module according to claim 7, wherein
the leakage reducing layer is provided so as to include a portion extending from the position facing the contact portion in a direction away from the insertion port.

10. An optical transmission device comprising:
an optical module; and
a cage including a first shield finger provided in contact with the optical module so as to provide electromagnetic shielding, the cage being configured to allow the optical module to be attachable thereto and detachable therefrom, wherein
the optical module includes
a module case,
a slider attached to the outside of the module case for releasing coming-off prevention from the cage, and
a leakage reducing layer intervening between the module case and the slider at a position facing the first shield finger to reduce leakage of an electromagnetic wave when the optical module is attached to the cage.

11. The optical transmission device according to claim 10, further comprising:
a circuit board on which the cage is mounted; and
a front plate including a hole through which an end portion of the cage is inserted, wherein
the cage includes a second shield finger provided in contact with an edge of the hole of the front plate so as to provide electromagnetic shielding.

12. The optical transmission device according to claim 11, wherein
the first shield finger and the second shield finger are located at positions overlapping each other.
